(19) United States
(12) Patent Application Publication
(10) Pub. No.: US 2025/0348254 A1
(43) Pub. Date: Nov. 13, 2025

(54) IMAGE FORMING SYSTEM, CONTROL METHOD THEREFOR, AND STORAGE MEDIUM STORING CONTROL PROGRAM THEREFOR

(71) Applicant: CANON KABUSHIKI KAISHA, Tokyo (JP)

(72) Inventor: TAKUMI MICHISHITA, Chiba (JP)

(21) Appl. No.: 19/189,707

(22) Filed: Apr. 25, 2025

(30) Foreign Application Priority Data
May 7, 2024 (JP) 2024-075169

(51) Int. Cl. G06F 3/12

(52) U.S. Cl. CPC G06F 3/1239; G06F 3/1203; G06F 3/1273

(57) ABSTRACT

An image forming system capable of preventing a residual printable number of sheets until reaching an upper limit number of sheets and the residual lending period from being discarded in vain. The image forming system including first and second image forming apparatuses each of which includes a print function, an obtaining unit that obtains the upper limit number of sheets printable within a predetermined period and a residual printable number until reaching the upper limit number within the predetermined period, a limiting unit that limits the print function when reaching the upper limit number within the predetermined period, an addition unit that adds the residual printable number of sheets of the first image forming apparatus to the upper limit number of sheets of the second image forming apparatus, and a controller that sets the residual printable number of the first image forming apparatus to zero.

### BACKGROUND OF THE INVENTION

### Field of the Invention

The present invention relates to an image forming system, a control method therefor, and a storage medium storing a control program therefor.

### Description of the Related Art

Conventionally, there is a method to charge a fee for a print sheet when printing by an image forming apparatus such as a multifunction peripheral. There are known charging methods, such as a click charging method and a fixed amount printing method are known. The click charging method is a method of paying an amount of money corresponding to the number of print sheets used for printing each time of printing. The fixed amount printing method is a method in which a user using an image forming apparatus pays a fixed amount of money every predetermined period, and thus is permitted to print up to the printable number of sheets set in advance within the predetermined period. In the fixed amount printing method, printing exceeding the printable number of sheets is stopped, or an additional fee for the number of printed sheets exceeding the printable number of sheets is charged.

Also, for example, in emerging countries, a rental business to rent an image forming apparatus is expanding. In addition to the click charging method and the fixed amount printing method, the rental business in the emerging countries includes a prepaid operation method. In the prepaid operation method, the printable number of sheets of an image forming apparatus and a lending period (use period) of the image forming apparatus are set under a condition that a fee is prepaid. In the prepaid operation method, when the printable number of sheets is reached or the lending period expires, printing of the image forming apparatus is stopped. Japanese Patent Laid-Open Publication No. 2022-110475 (One of two priority applications of US 20230359404 A1) discloses a system including a server, a printer, and a mobile terminal that are communicably connected to each other, and in which the server is notified of the printable number of sheets of the printer via the mobile terminal. In the system described in the above publication, the printable number of sheets of the printer can be increased by charging a fee from the mobile terminal.

In the prepaid operation scheme, for example, the image forming apparatus may fail or need to be replaced before the printable number of sheets is reached or the lending period expires. In this case, the residual number of sheets until the printable number of sheets is reached or the residual lending period is discarded in vain, which may cause a disadvantage in a user.

### SUMMARY OF THE INVENTION

The present invention provides a mechanism capable of preventing, for example, the residual printable number of sheets until reaching the upper limit number of sheets and the residual lending period from being discarded in vain.

Accordingly, an aspect of the present invention provides an image forming system including first and second image forming apparatuses each of which includes a print function configured to print on a print sheet, an obtaining unit configured to obtain an upper limit number of sheets printable within a predetermined period and a residual printable number of sheets printable until reaching the upper limit number of sheets within the predetermined period, a limiting unit configured to limit the print function when reaching the upper limit number of sheets within the predetermined period, an addition unit configured to add the residual printable number of sheets of the first image forming apparatus to the upper limit number of sheets of the second image forming apparatus, and a controller configured to set the residual printable number of sheets of the first image forming apparatus to zero.

According to the present invention, for example, it is possible to prevent the residual printable number of sheets until reaching the upper limit number of sheets and the residual lending period from being discarded in vain.

Further features of the present invention will become apparent from the following description of exemplary embodiments with reference to the attached drawings.

### BRIEF DESCRIPTION OF THE DRAWINGS

FIG. 1 is a block diagram illustrating an example of a hardware configuration of an image forming apparatus according to a first embodiment.

FIG. 2 is a block diagram illustrating an example of a software configuration of the image forming apparatus.

FIG. 3 is a view illustrating examples of print plans that can be used in the image forming apparatus.

FIG. 4 is a view illustrating a configuration example of an image forming system.

FIG. 5 is a flowchart illustrating a residual printable number takeover process executed in an image forming apparatus of a takeover source.

FIG. 6 is a flowchart illustrating a residual printable number takeover process executed in an image forming apparatus of a takeover destination.

FIG. 7A and FIG. 7B are views illustrating examples of screens displayed during execution of the residual printable number takeover process in the image forming apparatus of the takeover source.

FIG. 8A and FIG. 8B are views illustrating examples of screens displayed during execution of the residual printable number takeover process in the image forming apparatus of the takeover destination.

FIG. 9A is a view illustrating a state in which both the image forming apparatuses are capable of printing in a plan A.

FIG. 9B is a view illustrating a state where one image forming apparatus is capable of printing in the plan A and the other image forming apparatus is capable of printing in a plan B.

FIG. 9C is a view illustrating a state where one image forming apparatus is capable of printing in the plan B and the other image forming apparatus is capable of printing in the plan A.

FIG. 10 is a sequential chart illustrating a process performed between two image forming apparatuses and a mobile terminal according to a second embodiment.

### DESCRIPTION OF THE EMBODIMENTS

Hereafter, embodiments according to the present invention will be described in detail by referring to the drawings. However, the configurations described in the following embodiments are merely examples, and the scope of the present invention is not limited by the configurations described in the embodiments. For example, each unit constituting the present invention can be replaced with any configuration capable of exhibiting the same function. In addition, an arbitrary constituent may be added. Any two or more configurations (features) of the embodiments can be combined.

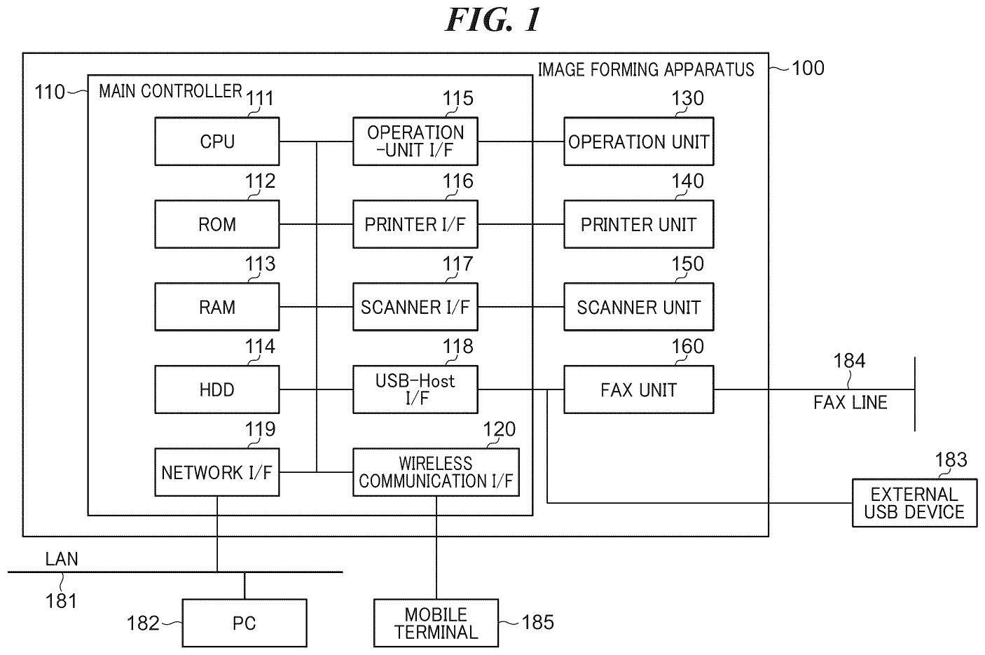

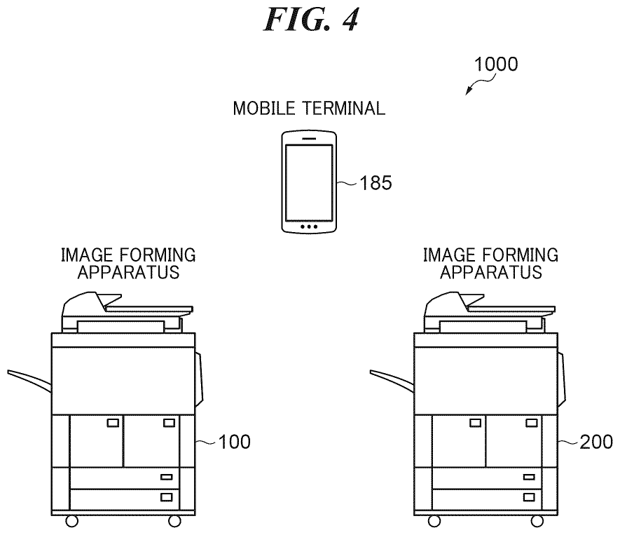

A first embodiment will now be described with reference to FIG. 1 through FIG. 9C. FIG. 1 is a block diagram illustrating an example of a hardware configuration of an image forming apparatus according to the first embodiment. The image forming apparatus 100 shown in FIG. 1 constitutes an image forming system 1000 (see FIG. 4). The image forming apparatus 100 includes a main controller 110, an operation unit 130, a printer unit 140, a scanner unit 150, and a FAX unit 160. The main controller 110 includes a CPU 111, a ROM 112, a RAM 113, an HDD 114, an operation-unit I/F 115, a printer I/F 116, a scanner I/F 117, a USB-Host I/F 118, a network I/F 119, and a wireless communication I/F 120.

The CPU 111 reads a control program for the main controller 110 stored in the ROM 112 to the RAM 113 and executes it. The ROM 112 stores a boot program of the main controller 110, an operating system, and various programs. The ROM 112 stores license information for enabling a function of the image forming apparatus 100, a control program related to security in addition to execution programs related to a scan operation and a print operation. The execution programs include a program for causing a computer to execute units and means of the image forming system 1000 (a control method for the image forming system).

The RAM 113 is used for storing a program and temporary data when the CPU 111 controls the main controller 110. The HDD 114 stores some applications and various data. In addition, the HDD 114 stores print data received from a PC 182 via the network I/F 119. Depending on a type of an image forming apparatus, an SSD may be connected as a storage device instead of the HDD 114. The SSD functions in the same manner as the HDD 114. Further, depending on a type of an image forming apparatus, the HDD 114 may be omitted.

The programs read from the ROM 112 and executed by the CPU 111 includes a printing application program. Then, the print application program converts the print data stored in the HDD 114 into image data printable by the printer unit 140. This image data is also stored in the HDD 114.

The programs read from the ROM 112 and executed by the CPU 111 includes a scanning application program. Then, the scan application program causes the scanner unit 150 to read image data and transfers the read image data to the HDD 114. In the HDD 114, the image data read by the scanner unit 150 is stored.

The operation-unit I/F 115 is an interface for communicating instructions input by a user of the image forming apparatus 100 through the operation unit 130 to the CPU 111. The operation-unit I/F 115 receives contents to be displayed on the operation unit 130 from the CPU 111 and transmits the contents to the operation unit 130. The operation unit 130 includes, for example, a liquid crystal display unit (display means) having a touch panel function, a keyboard, and the like. The liquid crystal display unit can display various screens such as a state of the image forming apparatus 100 and an operation menu screen, and can receive an instruction from a user. The screen display control on the liquid crystal display unit is performed by the CPU 111 (display control means) via the operation-unit I/F 115.

The printer I/F 116 is an interface for connecting the main controller 110 and the printer unit 140. The printer unit 140 performs printing on a recording medium based on the image data transferred from the HDD 114 via the printer I/F 116. The scanner I/F 117 is an interface for connecting the main controller 110 and the scanner unit 150. The scanner unit 150 includes a line sensor constituted by a CCD (Charge Coupled Device) or the like. The line sensor reads a document and generates image data of the document. The image data is transferred to the HDD 114 via the scanner I/F 117 and stored in the HDD 114. The image data can be printed by the printer unit 140.

The USB-Host I/F 118 is an interface for connecting the main controller 110 and a USB device. The USB device includes, for example, the FAX unit 160. The FAX unit 160 is connected to a FAX line 184, and performs FAX transmission of the image data transferred from the HDD 114 via the USB-Host I/F 118. The FAX unit 160 generates image data based on the received data and transfers the image data to the HDD 114 via the USB-Host I/F 118.

Note that the image data stored in the HDD 114 can be printed by the printer unit 140. An external USB device 183 is connected to the USB-Host I/F 118. The external USB device 183 is not particularly limited, and may be a USB memory, a USB-keyboard, or the like. The network I/F 119 connects the main controller 110 to a LAN 181 and supports communication with the PC 182 on the LAN.

The PC 182 can perform various operations on the image forming apparatus 100, for example, transmission and reception of the print data, an operation via a WEB browser, and transmission of a firmware file. The print data received via the network I/F 119 can also be printed immediately by the printer unit 140. In addition, when using functions such as hold printing, secure printing, and authentication printing, the image data is stored in the HDD 114 for a predetermined period.

The image forming apparatus 100 is also connected with a mobile terminal 185 via the wireless communication I/F 120. The mobile terminal 185 can perform various operations on the image forming apparatus 100, for example, transmission and reception of the print data, requests and reception of various processes, and transmission and reception of print count data including the printable number of sheets. Depending on the installation environment of the image forming apparatus 100, the image forming apparatus 100 may not be connected to the PC 182 or the mobile terminal 185.

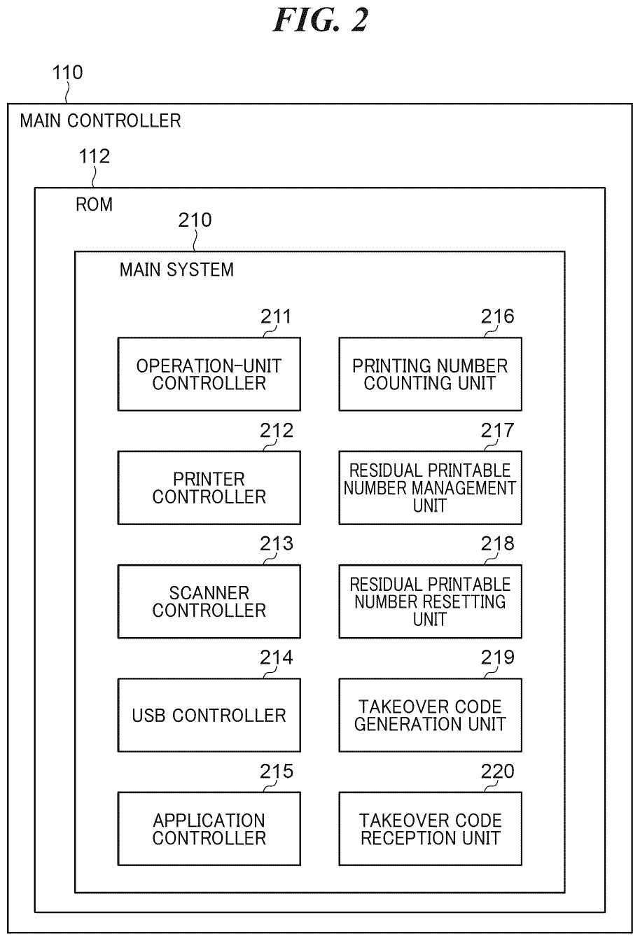

FIG. 2 is a block diagram illustrating an example of a software configuration of the image forming apparatus. Each software in FIG. 2 is executed by the CPU 111 of the main controller 110. A main system 210 as a program associated with this execution is stored in the ROM 112. As shown in FIG. 2, the main system 210 includes an operation-unit controller 211, a printer controller 212, a scanner controller 213, a USB controller 214, and an application controller 215.

The main system 210 includes a printing number counting unit 216, a residual printable number management unit 217, a residual printable number resetting unit 218, a takeover code generation unit (generation means) 219, and a takeover code reception unit 220. The operation-unit controller 211 is a program for controlling the operation unit 130 via the operation-unit I/F 115. The printer controller 212 is a program to control the printer unit 140 via the printer I/F 116.

The scanner controller 213 is a program to control the scanner unit 150 via the scanner I/F 117. The USB controller 214 is a program to control the FAX unit 160 and the external USB device 183 via the USB-Host I/F 118. The application controller 215 is a program group to achieve various functions of the image forming apparatus 100. The application controller 215 also includes httpd (Hyper Text Transfer Protocol Daemon), Ipd (Line Printer Daemon), a Web browser function, and a device information distribution function.

The printing number counting unit 216 counts the number of sheets printed by the printer unit 140, that is, the number of printed sheets. The printing number counting unit 216 can count the number of printed sheets for each of print conditions, such as color printing, monochrome printing, and a print sheet size, and a job type. The print number count unit 216 can also weight the printing number for each of the print conditions.

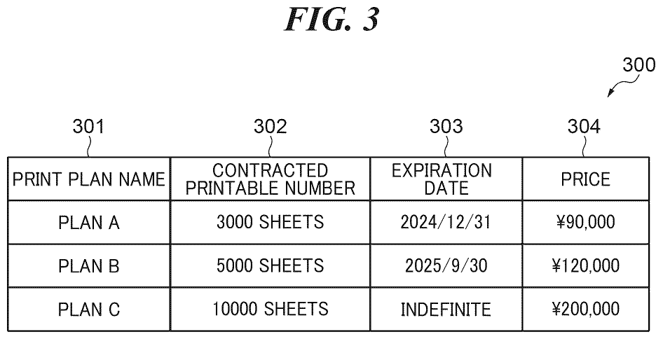

The residual printable number management unit 217 calculates and manages the residual printable number of sheets printable by the image forming apparatus 100 (an obtaining step). The “residual printable number” is the residual number of sheets up to the contracted printable number of sheets (the upper limit number of sheets) within a subscription contract period. The residual printable number is obtained by subtracting the number of printed sheets counted by the printing number counting unit 216 of the image forming apparatus 100 from a contracted printable number of sheets included in a print plan table 300 (FIG. 3).

As described above, in the present embodiment, the residual printable number management unit 217 functions as the obtaining means that obtains the contracted printable number of sheets and the residual printable number of sheets. The residual printable number management unit 217 also functions as a restriction means (a restriction step) that restricts the print function when the number of printed sheets reaches the contracted printable number of sheets 302 within a period of the subscription contract (within a predetermined period), which will be described below. In the present exemplary embodiment, the restriction is to stop the printing function, that is, to prohibit execution of the printing process by the printer unit 140. The operation unit 130 and the mobile terminal 185 (see FIG. 4) can receive an operation for a residual printable number takeover process described below. In this case, the residual printable number resetting unit 218 functions as a control means that controls to set the residual printable number managed by the residual printable number management unit 217 to zero (a control step).

When the operation unit 130 receives an operation for the residual printable number takeover process, the takeover code generation unit 219 generates a takeover code for the residual printable number takeover process to be displayed on the operation unit 130 or takeover data (transmission data) to the mobile terminal 185. Each of takeover code and takeover data is obtained by encrypting information including individual identification information (serial ID) and a residual printable number of an image forming apparatus of a takeover source, individual identification information of an image forming apparatus of a takeover destination with a common key.

Note that, even when another encryption technique is used or encryption is not performed, the takeover code or the takeover data may be generated by using a character string including the individual identification information of the takeover source and the takeover destination and the residual printable number as the information. The takeover code may be a combination of character strings or a barcode image such as a QR code (registered trademark), and is not particularly limited. The control of stopping the printing function by the residual printable number management unit 217 is performed when the takeover code or the transfer data is generated by the takeover code generation unit 219.

The takeover code reception unit 220 receives the information including the takeover code and the takeover data generated by the takeover code generation unit 219 and executes a decryption process. Thus, the information including the individual identification information and the residual printable number of the image forming apparatus of the takeover source, the individual identification information of the image forming apparatus of the takeover destination can be extracted. When the takeover code reception unit 220 confirms that the individual identification information of the takeover destination is appropriate as the takeover destination of the residual printable number, the takeover code reception unit 112 notifies the residual printable number management unit 217 of the fact. Then, the residual printable number management unit 217 adds the residual printable number of sheets of the image forming apparatus of the takeover source to the printable number of sheets of the image forming apparatus of the takeover destination (an addition step). In this way, in the present embodiment, the residual printable number management unit 217 also functions as the addition unit that adds the residual printable number of sheets. If the printable number of sheets of an image forming apparatus is not registered, the residual printable number of sheets to be taken over received by the takeover code reception unit 220 is used as the printable number of sheets for the image forming apparatus concerned.

FIG. 3 is a view illustrating examples of print plans that can be used in the image forming apparatus. A user using the image forming apparatus 100 has concluded a subscription contract with a provider providing a subscription service. In this case, the user may be an individual or a corporation. The subscription contract can be contracted by a counter charge method or a fixed amount printing method, for example, but in the present embodiment, the subscription contract shall be contracted by a prepaid operation method. In the counter charge method, a fee corresponding to the number of sheets printed by the image forming apparatus 100 is paid later. In the fixed amount printing method, a user who uses the image forming apparatus 100 pays a fixed amount of money every predetermined period (for example, one month), and thus printing can be performed up to the printable number of sheets set in advance within the predetermined period. In the prepaid operation method, when a user pays a fee in advance according to a print plan, the user is allowed to perform printing within a range of a printable number of sheets and within a validity period set in the print plan.

As shown in FIG. 3, the print plan table 300 includes a print plan name 301, a contracted printable number 302, an expiration date 303, and a price 304 as its items. The print plan name 301 is a name of a print plan. The contracted printable number 302 is an upper limit number of sheets printable in the print plan applied to the image forming apparatus 100. The expiration date 303 is the last date of a lending period during which the print plan is valid. The contracted printable number 302 is the upper limit number of sheets used for printing until the expiration date 303 (within a predetermined period). For example, even if the number of sheets printed by the image forming apparatus 100 up to the expiration date 303 does not reach the contracted printable number 302 and remains, the residual printable number becomes zero when the expiration date 303 is reached. The expiration date 303 may be set to be indefinite.

The price 304 is a fee to be paid in advance to a provider who provides a subscription service when a contract for a printing plan is concluded with the provider. The price 304 is generally set so that the price per print sheet decreases as the contracted printable number 302 increases, but in the present embodiment, the price is set assuming a usage pattern including the setting of the expiration date 303. The user preferably selects a desired print plan from the print plan table 300 in consideration of the printing volume assumed in the image forming apparatus 100 and concludes a contract.

FIG. 4 is a view illustrating a configuration example of the image forming system. As illustrated in FIG. 4, the image forming system 1000 includes the image forming apparatus 100, an image forming apparatus 200, and the mobile terminal 185, which are communicably connected to each other. The image forming apparatus 200 has the same configuration as the image forming apparatus 100, that is, has a printing function capable of printing on a print sheet as in the image forming apparatus 100. Although FIG. 4 shows a configuration in which the image forming system 1000 includes two image forming apparatuses, this is not limited. For example, three or more may be arranged, that is, at least two are arranged. The image forming system 1000 may omit the mobile terminal 185.

As described above, the user using the image forming apparatus 100 has concluded the subscription contract with the provider of the subscription service. The user owns and manages the image forming apparatus 100, the image forming apparatus 200, and the mobile terminal 185. Further, desired print plans are respectively registered for the image forming apparatus 100 and the image forming apparatus 200 by selecting in the print plan table 300 (see FIG. 3) included in the subscription contract. In the subscription contract, the residual printable number of sheets of one of the image forming apparatuses 100 and 200 can be taken over to the printable number of sheets of the other image forming apparatus. This process is referred to as a “residual printable number takeover process”. In the present embodiment, as an example, the image forming apparatus 100 acts as a takeover source (one image forming apparatus) of the residual printable number of sheets and the image forming apparatus 200 acts as a takeover destination (the other image forming apparatus) of the residual printable number of sheets.

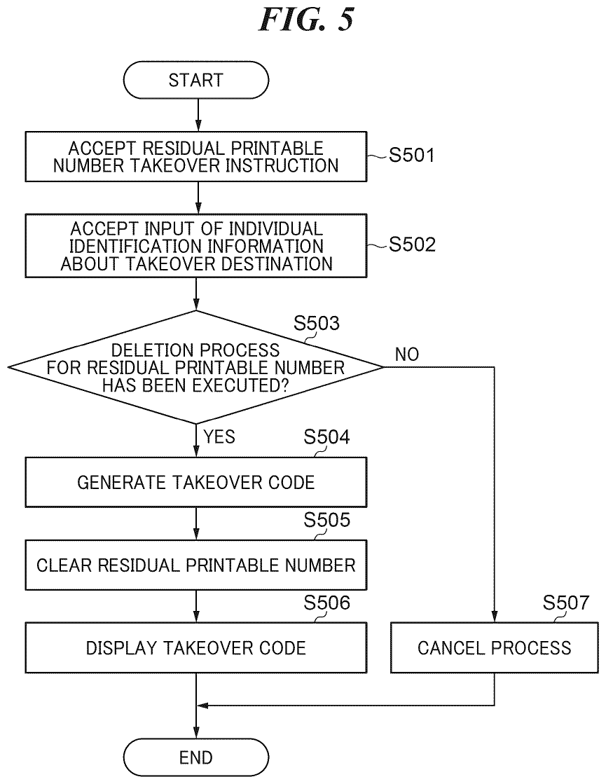

FIG. 5 is a flowchart illustrating the residual printable number takeover process executed in the image forming apparatus of the takeover source. The program based on the flowchart shown in FIG. 5 is stored in the ROM 112 of the image forming apparatus 100, which is the takeover source, and is executed by the CPU 111 of the image forming apparatus 100. As shown in FIG. 5, in a step S501, the CPU 111 of the image forming apparatus 100 controls the operation unit 130 to display the individual identification information and the residual printable number of sheets, and accepts a takeover instruction of the residual printable number via the operation unit 130. After the execution of the step S501, the process proceeds to a step S502.

In the step S502, the CPU 111 accepts an input of the individual identification information about the image forming apparatus 200 of the takeover destination via the operation unit 130. After the execution of the step S502, the process proceeds to a step S503.

In the step S503, the CPU 111 determines whether a deletion process for the residual printable number of the image forming apparatus 100, that is, a process of setting the residual printable number of the image forming apparatus 100 to zero has been executed. As a result of the determination in the step S53, when it is determined that the deletion process for the residual printable number has been executed, the process proceeds to a step S504. On the other hand, as a result of the determination in the step S503, it is determined that the deletion process for the residual printable number has not been executed, the process proceeds to a step S507.

In the step S504, the CPU 111 (the takeover code generation unit 219) generates a takeover code based on the individual identification information and the residual printable number of the image forming apparatus 100 of the takeover source and the individual identification information about the image forming apparatus 200 of the takeover destination. After the execution of the step S504, the process proceeds to a step S505.

In the step S505, the CPU 111 (the residual printable number resetting unit 218) clears the residual printable number managed by the residual printable number management unit 217 to zero. After the execution of the step S505, the process proceeds to a step S506.

In the step S506, the CPU 111 controls the operation unit 130 to display the takeover code generated in the step S504. After the step S506 is executed, the process is terminated. Note that, when the image forming apparatus 100 and the image forming apparatus 200 are not connected via the network, it is difficult to synchronize the takeover between the image forming apparatus 100 and the image forming apparatus 200. In order to solve this difficulty, it is preferable to execute the deletion process for the residual printable number together with displaying the takeover code.

The CPU 111 cancels the residual printable number takeover process executed in the image forming apparatus 100 in the step S507 and the process ends.

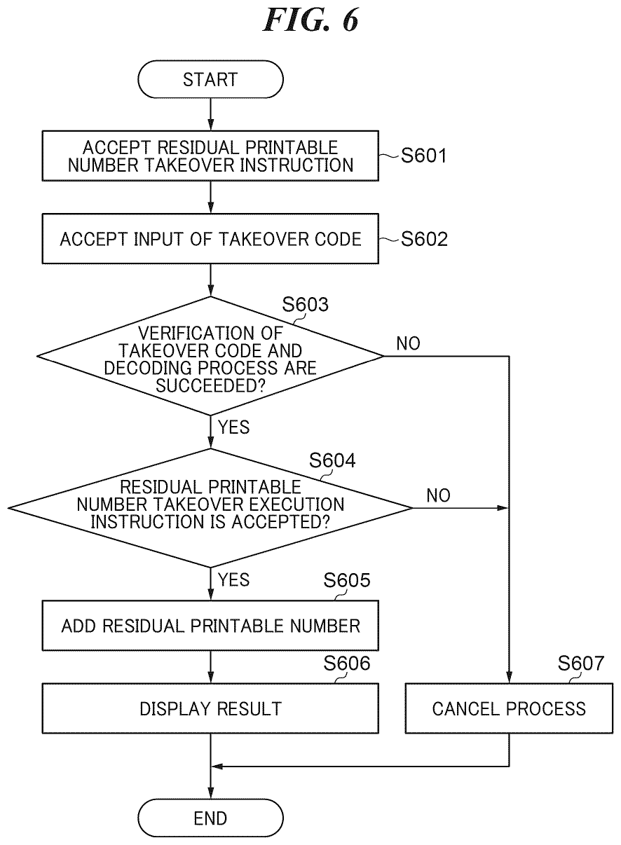

FIG. 6 is a flowchart illustrating the residual printable number takeover process that is executed in the image forming apparatus of the takeover destination. The program based on the flowchart shown in FIG. 6 is stored in a ROM 112 of the image forming apparatus 200, which is the takeover destination, and is executed by a CPU 111 of the image forming apparatus 200. As shown in FIG. 6, in a step S601, the CPU 111 of the image forming apparatus 200 accepts a takeover instruction of the residual printable number of the image forming apparatus 100, which is the takeover source, via an operation unit 130. After the execution of the step S601, the process proceeds to a step S602.

In the step S602, the CPU 111 controls the operation unit 130 to display a screen capable of accepting input of the takeover code, and accepts input of the takeover code on the screen. When the takeover code is input, the process proceeds to a step S603.

In the step S603, the CPU 111 (the takeover code reception unit 220) determines whether verification of the takeover code input in the step S602 and the decryption process are succeeded. As a result of the determination in the step S603, when it is determined that the verification of the takeover code and the execution of the decryption process are succeeded, the process proceeds to a step S604. Note that the individual identification information and the residual printable number of the image forming apparatus of the takeover source and the individual identification information of the image forming apparatus of the takeover destination can be extracted by the verification of the takeover code and the execution of the decryption process. On the other hand, as a result of the determination in the step S603, when it is determined that the verification of the takeover code or the execution of the decryption process is failed, the process proceeds to a step S607. The verification of the takeover code and the execution of the decryption process are determined to be failed when the takeover code input in the step S602 is invalid, when the individual identification information of the image forming apparatus of the takeover destination does not match the individual identification information of the image forming apparatus 200, or the like.

In the step S604, the CPU 111 controls the operation unit 130 to display a screen including the individual identification information, the residual printable number, and the printable number of sheets in the image forming apparatus 200 after taking over the residual printable number. Then, the CPU 111 determines whether a residual printable number takeover execution instruction is accepted on the screen. As a result of the determination, when it is determined that the takeover execution instruction is accepted, the process proceeds to a step S605. On the other hand, when it is determined that the takeover execution instruction is not accepted, that is, when it is determined that cancellation is instructed on the screen, the process proceeds to the step S607.

In the step S605, the CPU 111 (the residual printable number management unit 217) adds the residual printable number displayed in the step S604 to the printable number of sheets in the image forming apparatus 200. After the execution of the step S605, the process proceeds to a step S606.

In the step S606, the CPU 111 controls the operation unit 130 to display the result of the execution in the step S605, and the process ends.

In the step S607, the CPU 111 controls the operation unit 130 to display a screen indicating the unsuccessful determination in the step S603 as an error, and cancels the residual printable number takeover process executed in the image forming apparatus 200, and the process ends.

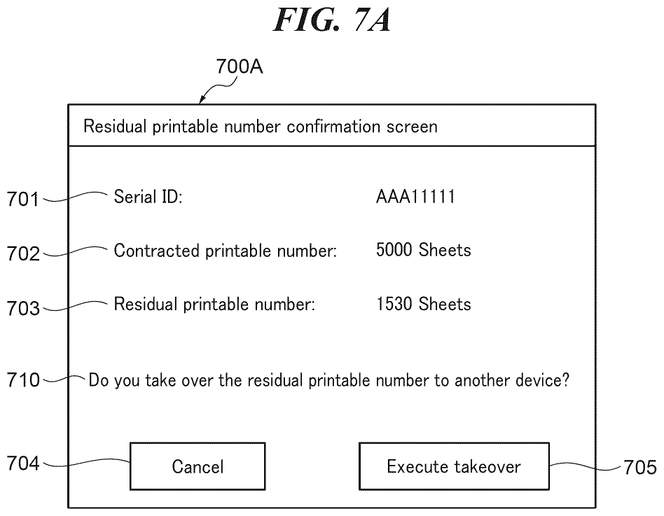

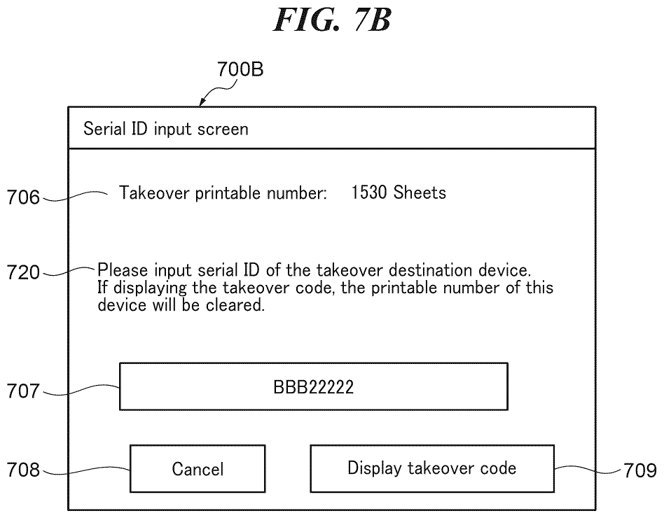

FIG. 7A and FIG. 7B are views illustrating examples of screens displayed during execution of the residual printable number takeover process in the image forming apparatus of the takeover source. FIG. 7A illustrates a residual printable number confirmation screen, and FIG. 7B illustrates a serial ID input screen, both of which are displayed on the operation unit 130 of the image forming apparatus 100. The residual printable number confirmation screen 700A shown in FIG. 7A is displayed in the step S501. The residual printable number confirmation screen 700A includes a serial ID 701, a contracted printable number 702, a residual printable number 703, a cancel button 704, an execution button 705, and a message 710. The serial ID 701 is the individual identification information of the image forming apparatus 100. The contracted printable number 702 is the printable number of sheets of any one of the plans A, B, and C in the print plan table 300 (see FIG. 3), and shows 5000 sheets of the plan B in FIG. 7A.

The residual printable number 703 is the residual printable number subjected to the takeover. As described above, this number of sheets is generated by the takeover code generation unit 219. The message 710 is a message for confirming the execution of the residual printable number takeover process. When the residual printable number takeover process is executed in accordance with the message 710, the use operates the execution button 705. On the other hand, when the execution of the residual printable number takeover process is cancelled, the user operates the cancel button 704. In this way, the residual printable number confirmation screen 700A is a selection screen for selecting whether to execute the residual printable number takeover process (addition of the residual printable number of the image forming apparatus 200 of the takeover destination). The residual printable number confirmation screen 700A may include the plan names, the expiration dates, the prices, and the like of the plans A, B, and C in the print plan table 300 (see FIG. 3).

The serial ID input screen 700B shown in FIG. 7B is displayed in the steps S502 and S503. The serial ID input screen 700B is displayed when the execution button 705 is operated. The serial ID input screen 700B includes a takeover printable number 706, a takeover destination serial ID input field 707, a cancel button 708, an execution button 709, and a message 720.

The takeover printable number 706 is the residual printable number to be taken over, similarly to the residual printable number 703. The individual identification information of the image forming apparatus 200 that is the takeover destination is input to the takeover destination serial ID input field 707. The message 720 prompts a user to input the individual identification information of the image forming apparatus of the takeover destination in the takeover destination serial ID input field 707 and indicates a result that will be caused in the image forming apparatus 100 of the takeover source when the takeover code is displayed. After inputting the serial ID to the takeover destination serial ID input field 707, when the display of the takeover code is executed as indicated by the message 720, the execution button 709 is operated. On the other hand, when the display of the takeover code is canceled, the cancel button 708 is operated.

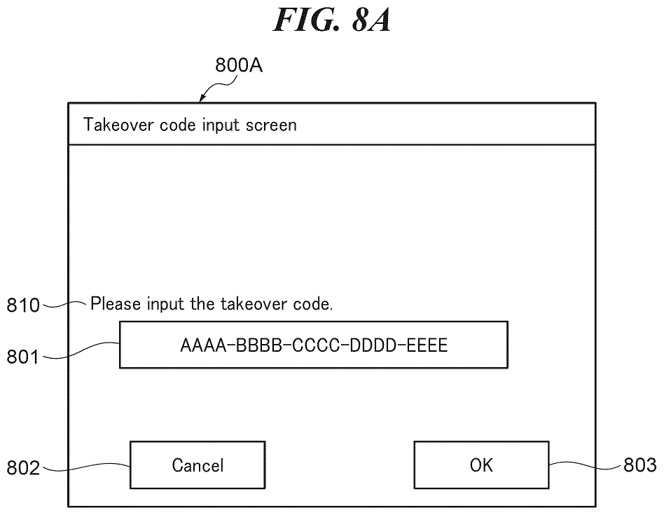

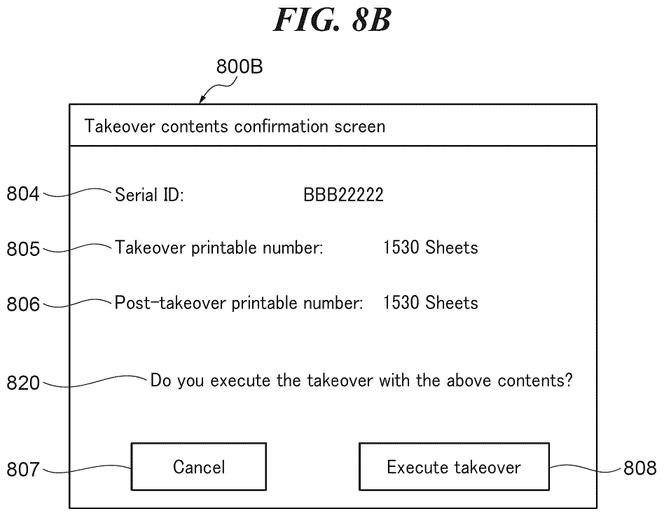

FIG. 8A and FIG. 8B are views illustrating examples of screens displayed during execution of the residual printable number takeover process in the image forming apparatus of the takeover destination. FIG. 8A illustrates a takeover code input screen, and FIG. 8B illustrates a takeover contents confirmation screen, both of which are displayed on the operation unit 130 of the image forming apparatus 200. The takeover code input screen 800A shown in FIG. 8A is displayed in the step S602. The takeover code input screen 800A includes a residual printable number takeover code input field 801, a cancel button 802, an execution button 803, and a message 810. When the execution button 709 of the image forming apparatus 100 is operated, the takeover code displayed on the operation unit 130 of the image forming apparatus 100 is input to the residual printable number takeover code input field 801.

As described above, the information displayed on the operation unit 130 of the image forming apparatus 100 can be input on the takeover code input screen 800A. Then, based on the input information, the residual printable number of the image forming apparatus 100 can be added to the printable number of the image forming apparatus 200 (see a post-takeover printable number 806 in FIG. 8B).

The message 810 prompts the user to input the takeover code in the residual printable number takeover code input field 801. After the takeover code is input to the residual printable number takeover code input field 801, the cancel button 802 or the execution button 803 can be operated. When the execution button 803 is operated, the takeover contents confirmation screen 800B shown in FIG. 8B is displayed. When the cancel button 802 is operated, the execution of the residual printable number takeover process in the image forming apparatus 200 is canceled.

The takeover contents confirmation screen 800B shown in FIG. 8B is displayed in the step S604. The takeover contents confirmation screen 800B includes a serial ID 804, a takeover printable number 805, the post-takeover printable number 806, a cancel button 807, an execution button 808, and a message 820. The serial ID 804 is the individual identification information of the image forming apparatus 200, and is the same as the individual identification information of the image forming apparatus 200 input to the takeover destination serial ID input field 707 in the case shown in FIG. 8B. The takeover printable number 805 is the residual printable number to be taken over as with the takeover printable number 706. The post-takeover printable number 806 is the printable number of the image forming apparatus 200 after the residual printable number is taken over. The message 820 confirms whether to execute the residual printable number takeover process in the image forming apparatus 200 with the contents displayed from the serial ID 804 to the post-takeover printable number 806. Then, when the residual printable number takeover process is executed in accordance with the message 820, the execution button 808 is operated. On the other hand, when canceling the execution of the residual printable number takeover process, the cancel button 807 is operated.

Next, an application example (modification) in which the residual printable number takeover process is applied to the plans in the print plan table 300 will be described. The residual printable number takeover processes, that is, the addition of the residual printable number in the image forming apparatus 200 and the control for setting the residual printable number in the image forming apparatus 100 to zero are respectively performed, for example, when a failure occurs in the print function of the image forming apparatus 100. In addition, the processes are performed when the replacement of the image forming apparatus 100 is needed.

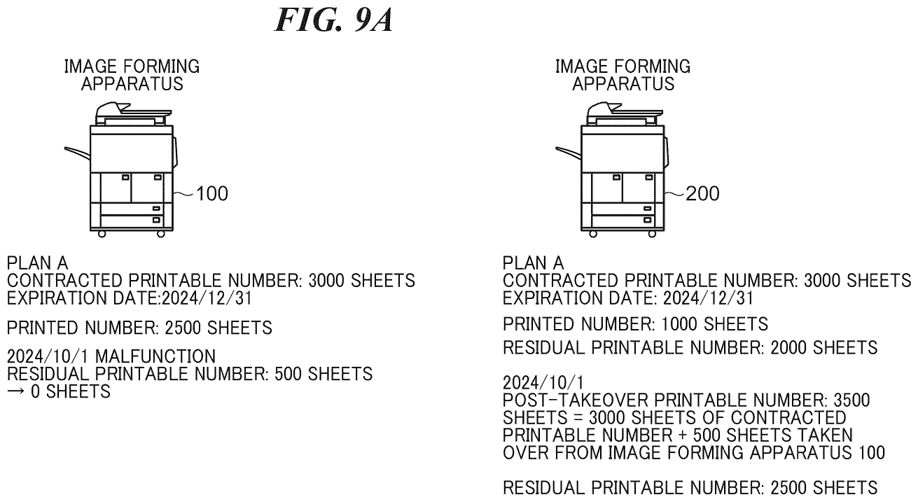

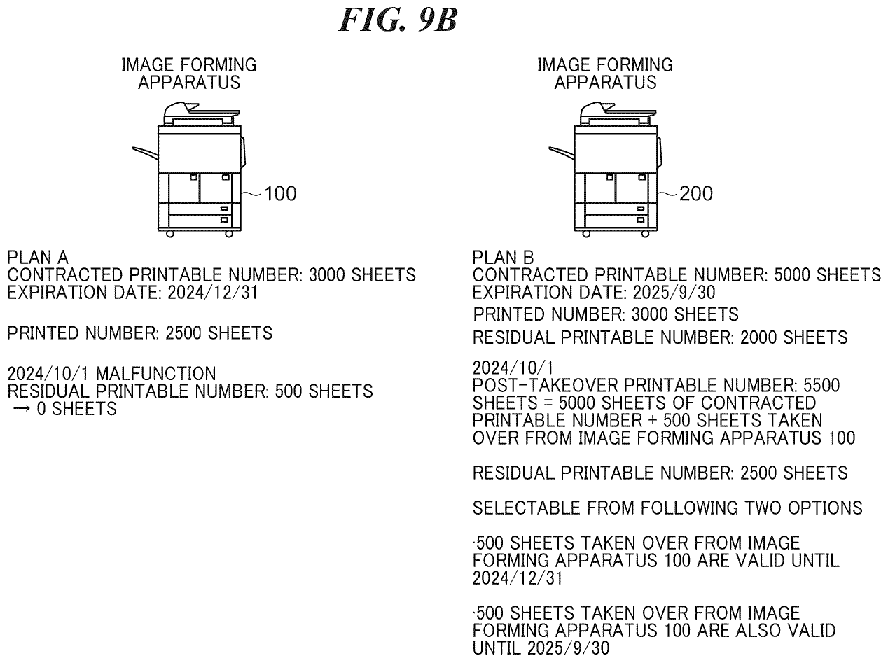

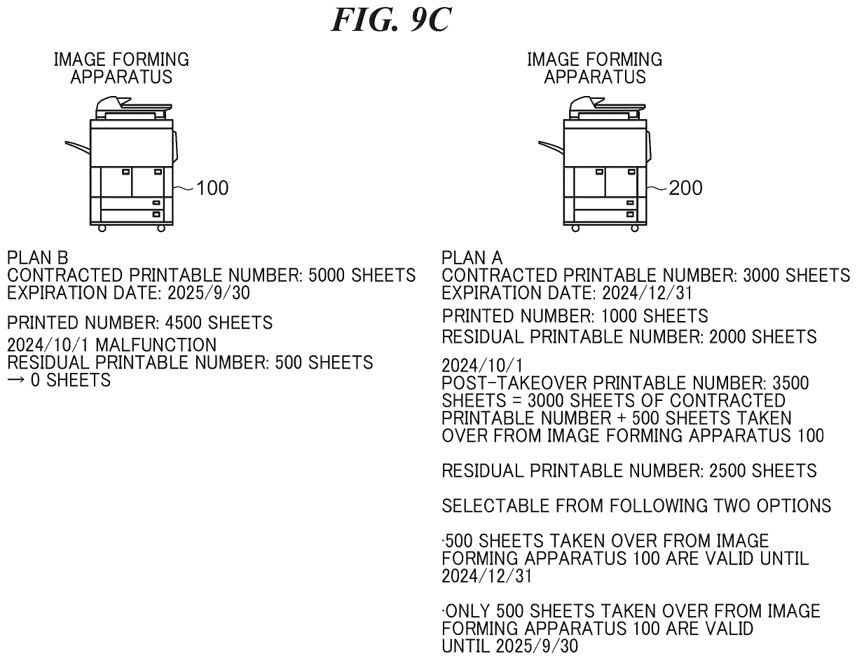

FIG. 9A is a view illustrating a state in which the image forming apparatus 100 and the image forming apparatus 200 are capable of printing in the plan A. As shown in FIG. 9A, the plan A defines the contracted printable number of sheets (upper limit number of sheets) as 3000 sheets and the expiration date as Dec. 31, 2024. In such a state, for example, the image forming apparatus 100 shall fail on Oct. 1, 2024. In addition, it is assumed that the image forming apparatus 100 at this time has already printed 2500 sheets and thus the residual printable number is 500 sheets. The residual printable number of 500 sheets is reduced to zero by the residual printable number takeover process in the image forming apparatus 100. On the other hand, it is assumed that the image forming apparatus 200 has already printed 1000 sheets at the time of Oct. 1, 2024 on which the image forming apparatus 100 failed, and the residual printable number is 2000 sheets.

Then, when the residual printable number takeover process in the image forming apparatus 200 is performed, the printable number becomes 3500 sheets by adding the residual printable number (500 sheets) taken over from the image forming apparatus 100 to the contracted printable number (3000 sheets) in the plan A. The number of 3500 sheets exceeds the original contracted printable number (3000 sheets) in the plan A, but the sheets can be used until the expiration date (Dec. 31, 2024) without any problem. As described above, the image forming apparatus 200 has already printed 1000 sheets. Therefore, the residual printable number of sheets that can be actually used for printing is 2500 sheets.

FIG. 9B is a view illustrating a state where the image forming apparatus 100 is capable of printing in the plan A and the image forming apparatus 200 is capable of printing in the plan B. As shown in FIG. 9B, the contents of the plan A are the same as the contents shown in FIG. 9A, and the plan B defines the contracted printable number as 5000 sheets and the expiration date as Sep. 30, 2025. In this state, for example, the image forming apparatus 100 shall fail in Oct. 1, 2024. In addition, it is assumed that 2500 sheets have been printed by the image forming apparatus 100 at this time and the residual printable number is 500 sheets. The number of 500 sheets is reduced to zero by the residual printable number takeover process in the image forming apparatus 100.

On the other hand, it is assumed that the image forming apparatus 200 has already printed 3000 sheets at the time of Oct. 1, 2024 on which the image forming apparatus 100 failed, and the residual printable number is 2000 sheets. Then, when the residual printable number takeover process in the image forming apparatus 200 is performed, the printable number becomes 5500 sheets by adding the residual printable number (500 sheets) taken over from the image forming apparatus 100 to the contracted printable number (5000 sheets) in the plan B. The number of 5500 sheets exceeds the original contracted printable number (5000 sheets) in the plan B. The residual printable number (500 sheets) taken over from the image forming apparatus 100 among the 5500 sheets can select one of the following two options. This selection is determined by, for example, a special contract in the subscription contract.

In a first option, the residual printable number (500 sheets) taken over from the image forming apparatus 100 can be used until the expiration date of the plan A (Dec. 31, 2024). In the second choice, the residual printable number (500 sheets) taken over from image forming apparatus 100 can be used until the expiration date of the plan B (Sep. 30, 2025).

FIG. 9C is a view illustrating a state where the image forming apparatus 100 is capable of printing in the plan B and the image forming apparatus 200 is capable of printing in the plan A. As shown in the FIG. 9C, the contents of the plans A and B are the same as the contents shown in FIG. 9B. In this state, for example, the image forming apparatus 100 shall fail on Oct. 1, 2024. In addition, it is assumed that 4500 sheets have been printed by the image forming apparatus 100 at this time and the residual printable number is 500 sheets. The residual printable number of 500 sheets is reduced to zero by the residual printable number takeover process in the image forming apparatus 100.

On the other hand, it is assumed that the image forming apparatus 200 has already printed 1000 sheets at the time of Oct. 1, 2024 on which the image forming apparatus 100 failed, and the residual printable number is 2000 sheets. Then, when the residual printable number takeover process in the image forming apparatus 200 is performed, the printable number becomes 3500 sheets by adding the residual printable number (500 sheets) taken over from the image forming apparatus 100 to the contracted printable number (3000 sheets) in the plan A. The number of 3500 sheets exceeds the original contracted printable number (3000 sheets) in the plan A. The residual printable number (500 sheets) taken over from the image forming apparatus 100 among the 3500 sheets can select one of the following two options. This selection is determined by, for example, a special contract in the subscription contract.

In a first option, the residual printable number (500 sheets) taken over from the image forming apparatus 100 is originally valid for use until the expiration date of the plan B (Sep. 30, 2025), but can be used until the expiration date of the plan A (Dec. 31, 2024). In a second option, the residual printable number (500 sheets) taken over from image forming apparatus 100 is originally valid for use until the expiration date (Sep. 30, 2025) of the plan B, and can be used until the expiration date (Sep. 30, 2025) as-is.

As described above, in any application examples, when the residual printable number occurs before the number of printed sheets reaches the contracted printable number of sheets in the image forming apparatus 100, the residual printable number can be taken over to the image forming apparatus 200. This prevents the residual printable number in the image forming apparatus 100 from being discarded in vain. As described above, in the image forming system 1000, when the image forming apparatus 100 cannot be used due to a failure or the like, the image forming apparatus 200 can compensate for the failure. If there is no takeover destination in the residual printable number takeover process or the expiration date of the print plan in the takeover destination has expired, it is preferable that the fact is notified to the user in the takeover source. As a result, the user enables the takeover of the residual printable number to the takeover destination.

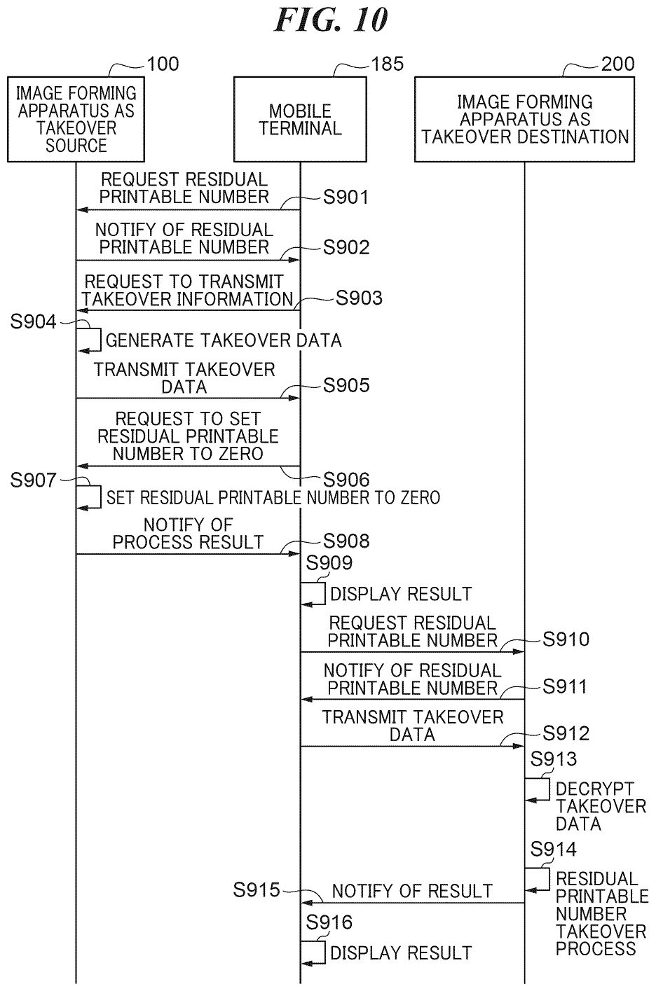

Hereinafter, a second embodiment will be described with reference to FIG. 10. A description will be made focusing on differences from the above-described embodiment, and the descriptions of the same matters will be omitted. In the present embodiment, the image forming apparatus 100, the image forming apparatus 200, and the mobile terminal 185 are connected to each other by wireless communication. Unlike the first embodiment, the residual printable number takeover process is instructed not via the operation unit 130 but via the mobile terminal 185. FIG. 10 is a sequential chart illustrating a process performed between the two image forming apparatuses and the mobile terminal according to the second embodiment. As shown in FIG. 10, in a step S901, the mobile node 185 requests a notification of the residual printable number from the image forming apparatus 100.

In a step S902, the image forming apparatus 100 responds to the request in the step S901 and notifies the mobile terminal 185 of the residual printable number. Thus, the mobile terminal 185 can obtain the residual printable number of the image forming apparatus 100. The mobile terminal 185 holds the individual identification information of the image forming apparatus 100 in advance when the mobile terminal 185 is connected to the image forming apparatus 100. The mobile terminal 185 can display the takeover information in the same manner as the residual printable number confirmation screen 700A on the basis of the individual identification information and the residual printable number and accept the residual printable number takeover process execution instruction.

In a step S903, the mobile terminal 185 requests the image forming apparatus 100 to transmit the takeover information.

In a step S904, the image forming apparatus 100 generates takeover data for the residual printable number takeover process in accordance with the request in the step S903. As described above, the takeover code generation unit 219 generates the takeover data.

In a step S905, the image forming apparatus 100 transmits the takeover data generated in the step S904 to the mobile terminal 185.

When receiving the takeover data transmitted in the step S905, the mobile terminal 185 requests the image forming apparatus 101 to set the residual printable number to zero in a step S906.

In a step S907, the image forming apparatus 100 sets the residual printable number to zero as requested in the step S906. As described above, the residual printable number resetting unit 218 sets the residual printable number to zero.

When the residual printable number is set to zero in the step S907, the image forming apparatus 100 notifies the mobile terminal 185 of a control result (a process result) in a step S908.

In a step S909, the mobile terminal 185 displays the takeover data received in the step S906 and the control result notified in the step S908.

In a step S910, the mobile device 185 requests a notification of the residual printable number from the image forming apparatus 200.

In a step S911, the image forming apparatus 200 responds to the request in the step S910 and notifies the mobile terminals 185 of the residual printable number. Thus, the mobile terminal 185 can obtain the residual printable number of the image forming apparatus 200. The mobile terminal 185 holds the individual identification information of the image forming apparatus 200 in advance when the mobile terminal 185 is connected to the image forming apparatus 200. The mobile terminal 185 can display the takeover information similar to the takeover contents confirmation screen 800B on the basis of the individual identification information and the residual printable number and accept the residual printable number takeover process execution instruction.

In a step S912, the mobile terminal 185 transmits the takeover data to the image forming apparatus 200.

When the image forming apparatus 200 receives the takeover data transmitted in the step S912, the takeover code receiving unit 220 of the image forming apparatus 200 verifies the takeover data and executes the decryption process in a step S913. Thus, the information including the residual printable number of the image forming apparatus 100 of the takeover source can be extracted.

When the verification of the takeover code and the execution of the decryption process are succeeded, the residual printable number management unit 217 of the image forming apparatus 200 executes the residual printable number takeover process of adding the residual printable number to the printable number of sheets of the image forming apparatus 200 in a step S914.

When the process was executed correctly in the step S914, the image forming apparatus 200 notifies the mobile terminal 185 of the execution result in a step S915.

In a step S916, the mobile terminal 185 displays the result notified in the step S915.

As described above, by using the mobile terminal 185, it is possible to reduce the complexity of the user moving back and forth between the image forming apparatus 100 and the image forming apparatus 200 when performing the residual printable number takeover process. Further, the contract information may be managed by an application on the mobile terminal 185. Alternatively, the contract information can be managed by communicating with a management server of a manufacturer by the mobile terminal 185 even if the image forming apparatus itself is not connected to an external network.

### Other Embodiments

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2024-075169, filed May 7, 2024, which is hereby incorporated by reference herein in its entirety.

What is claimed is:

1. An image forming system comprising:
first and second image forming apparatuses each of which includes;
a print function configured to print on a print sheet;
an obtaining unit configured to obtain an upper limit number of sheets printable within a predetermined period and a residual printable number of sheets printable until reaching the upper limit number of sheets within the predetermined period;
a limiting unit configured to limit the print function when reaching the upper limit number of sheets within the predetermined period;
an addition unit configured to add the residual printable number of sheets of the first image forming apparatus to the upper limit number of sheets of the second image forming apparatus; and
a controller configured to set the residual printable number of sheets of the first image forming apparatus to zero.

2. The image forming system according to claim 1, wherein the addition by the addition unit and the control for setting the residual printable number of sheets to zero by the controller are performed in a case where the print function of the first image forming apparatus fails or a case where the first image forming apparatus needs to be replaced.

3. The image forming system according to claim 1, wherein each of the first and second image forming apparatuses includes:
a display unit configured to display a screen; and
a display controller configured to control the display unit to display the screen.

4. The image forming system according to claim 3, wherein the display controller of the first image forming apparatus controls to display a selection screen for selecting whether to perform the addition by the addition unit on the display unit of the first image forming apparatus.

5. The image forming system according to claim 4, wherein the residual printable number of sheets of the first image forming apparatus is displayed on the selection screen.

6. The image forming system according to claim 4, further comprising a generation unit configured to generate information including the residual printable number of sheets of the first image forming apparatus in a case where the addition by the addition unit is selected on the selection screen.

7. The image forming system according to claim 6, wherein the controller sets the residual printable number to zero in a case where the information is generated by the generation unit.

8. The image forming system according to claim 6, wherein the display controller controls to display the information generated by the generation unit on the display unit of the first image forming apparatus.

9. The image forming system according to claim 8, wherein the display controller of the second image forming apparatus controls to display an input screen on the display unit of the second image forming apparatus, the input screen being used to input the information displayed on the display unit of the first image forming apparatus.

10. The image forming system according to claim 9, wherein the addition unit adds the residual printable number of sheets of the first image forming apparatus to the upper limit number of sheets of the second image forming apparatus based on the information input to the input screen.

11. The image forming system according to 1, wherein the limiting unit stops the print function as a limitation of the print function.

12. A control method for an image forming system including first and second image forming apparatuses each of which includes a print function capable of printing on a print sheet, the control method comprising:
obtaining an upper limit number of sheets printable within a predetermined period and a residual printable number of sheets printable until reaching the upper limit number of sheets within the predetermined period;
limiting the print function when reaching the upper limit number of sheets within the predetermined period;
adding the residual printable number of sheets of the first image forming apparatus to the upper limit number of sheets of the second image forming apparatus; and
setting the residual printable number of sheets of the first image forming apparatus to zero.

13. A non-transitory computer-readable storage medium storing a control program causing a computer to execute a control method for an image forming system including first and second image forming apparatuses each of which includes a print function capable of printing on a print sheet, the control method comprising:
obtaining an upper limit number of sheets printable within a predetermined period and a residual printable number of sheets printable until reaching the upper limit number of sheets within the predetermined period;
limiting the print function when reaching the upper limit number of sheets within the predetermined period;
adding the residual printable number of sheets of the first image forming apparatus to the upper limit number of sheets of the second image forming apparatus; and
setting the residual printable number of sheets of the first image forming apparatus to zero.
